(19) United States
(12) Patent Application Publication
(10) Pub. No.: US 2001/0055007 A1
(43) Pub. Date: Dec. 27, 2001

(54) Liquid crystal apparatus

(76) Inventors: Seishi Miura, Sagamihara-shi (JP); Hideo Mori, Yokohama-shi (JP); Yasufumi Asao, Atsugi-shi (JP)

Correspondence Address: FITZPATRICK CELLA HARPER & SCINTO, 30 ROCKEFELLER PLAZA, NEW YORK, NY, 10112, US

(21) Appl. No.: 09/822,173

(22) Filed: Apr. 2, 2001

(30) Foreign Application Priority Data
Apr. 5, 2000 (JP) 103436

(51) Int. Cl. G09G 5/00

(52) U.S. Cl. 345/204

(57) ABSTRACT

A liquid crystal apparatus capable of exhibiting a good display characteristic is provided even by using a liquid crystal of, which the voltage-transmittance characteristic means depending on temperature change. The liquid crystal apparatus includes: a liquid crystal device including a pair of substrates and a liquid crystal disposed between the substrates, a digital signal processing unit for converting a received digital video signal so as to conform to an electrooptical characteristic of the liquid crystal, and a D/A converter for converting the converted digital signal into an analog signal for controlling the optical state of the liquid crystal, wherein both an input/output characteristic of the D/A converter and signal processing by the digital signal processing unit are controlled so as to apply a voltage conforming to the electrooptical characteristic of the liquid crystal.

### FIELD OF THE INVENTION AND RELATED ART

The present invention relates to a liquid crystal apparatus as represented by a liquid crystal display apparatus including a liquid crystal device used in a flat panel display, a projection display, a light valve for a printer, etc.

As a representative liquid crystal mode adopted in a nematic liquid crystal display device extensively used as a display device using active devices, such as TFTs (thin film transistors), the twisted nematic (TN) mode (disclosed by M. Schadt and W. Helfrich: Applied Physics Letters, Vol. 18, No. 4 (Feb. 15, 1971), pp. 127-128) has been widely used. On the other hand, in recent years, liquid crystal displays according to the IPS (in-plane switching) mode and the VA (vertical alignment) mode have been proposed to provide an improvement to the viewing angle characteristic, which has been problematic in the conventional liquid crystal display devices. As mentioned above, various liquid crystal drive modes are known for use in TFT-driven display devices using nematic liquid crystals, but according to any of the liquid crystal drive modes, the response speed is slow as represented by a response time of several tens msec or loner, so that a further improved response speed is desired.

For improving the response speed of such conventional nematic liquid crystal devices, some liquid crystal drive modes using a liquid crystal showing chiral smectic phase, i.e., a chiral smectic liquid crystal, have been proposed, inclusive of drive modes using “a short pitch-type ferroelectric liquid crystal”, “a polymer-stabilized ferroelectric liquid crystal” and “a threshold-less anti-ferroelectric liquid crystal”. These modes of liquid crystal devices are reported to exhibit a high-speed responsiveness as represented by a response time of sub-millisecond or shorter, while they have not yet been commercialized.

On the other hand, our research group has proposed a type of liquid crystal device (in Japanese Laid-Open Patent Application (JP-A) 2000-338464 corresponding to U.S. patent application Ser. No. 09/333,338,426 and JP-A 2000-010076) where liquid crystal molecules of a material showing a phase transition series on temperature decrease of isotropic liquid phase (Iso)-cholesteric phase (Ch)-chiral smectic C phase (SmC*) or of isotropic liquid phase (Iso)-chiral smectic C phase (SmC*) are monostabilized at a position inside an edge of its imaging cone, and the smectic layer orientation directions of the molecules are uniformized to one of two possible directions, e.g., by applying either a positive or a negative voltage at the time of Ch-SmC* phase transition or Iso-SmC* phase transition. As a result, it becomes possible to provide a liquid crystal device which can exhibit a high response speed, allow a gradation control, and exhibit excellent motion picture characteristic and a high luminance. The type of liquid crystal device can also be produced at a high mass productivity. Compared with the above-mentioned various smectic modes, this type of device (herein representatively referred to as a DC monostabilized smectic liquid crystal device) allows the use of a liquid crystal showing a smaller spontaneous polarization, so that it is well-matched with active devices, such as TFT. The DC-monostabilized smectic liquid crystal device exhibits little hysteresis, thus allowing a stable halftone display.

As described above, the commercialization of chiral smectic liquid crystal devices, particularly a DC-monostabilized smectic liquid crystal device, is expected so as to solve the problem of slow response speed involved in the conventional TFT-liquid crystal displays using a nematic liquid crystal.

As a known difficulty, however, a smectic liquid crystal device has a voltage-transmittance (V-T) characteristic which remarkably varies depending on temperatures. In order to provide a good display state by using such a device over a wide temperature range, it is necessary to change input signals depending on liquid crystal characteristics at respective temperatures (i.e., to effect a gamma (γ)-correction. JP-A 11-311773 has proposed to change drive conditions depending on temperature-dependent liquid crystal characteristics but does not refer to a specific correction method depending on temperatures.

Various schemes may be conceived of for such gamma-correction.

First, a scheme of converting an 8-bit digital signal into again an 8-bit digital signal. If this scheme of converting an 8-bit digital signal into an 8-bit digital signal is applied to gamma-correction of voltage-transmittance characteristic of a liquid crystal which is not ordinarily represented as a linear relationship by using a D/A converter showing a linear conversion characteristic, it becomes impossible to reproduce the whole gradation levels due to a remarkable difference between the electrooptical (V-T) characteristic of a liquid crystal and the conversion characteristic of the D/A converter.

Next, a scheme of using a D/a conversion characteristic conforming to the voltage-transmittance (V-T) characteristic of a liquid crystal may be conceived of. This may be achieved by using a D/A converter showing a D/A conversion characteristic conforming to the V-T characteristic of the liquid crystal. In this case, however, it is difficult to obtain a good gradational expression over the entire temperature range as the V-T characteristic of a liquid crystal remarkably varies at different temperatures. Moreover, a D/A converter having such a nonlinear D/A conversion characteristic requires a complicated circuit, and the use thereof incurs an increase in the entire circuit size.

Further, a scheme of converting an 8-bit digital signal into a 10-bit digital signal is conceived of. In the case of converting an 8-bit digital signal into a 10-bit digital signal and using a 10-bit D/A converter, it is possible to obviate the above-mentioned lack of gradations to provide a good display characteristic even if the D/A converter has a linear conversion characteristic. This case however incurs an increase in bus width at the interface (I/F) with the liquid crystal panel, and thus an increase in number of pins, leading to an increase in system size. It is an ordinary practice in a liquid crystal display apparatus to supply video or picture signals in division through a plurality of buses in order to lower the dot rate. For example, in the case of parallel transmission of 4 video signals each, the transmission of 8-bit video signal requires 32 (=8×4) pins whereas the transmission of 10-bit video signals required 40 pins.

### SUMMARY OF THE INVENTION

In view of the above-mentioned problems of the prior art, a principal object of the present invention is to provide a liquid crystal apparatus allowing a good display performance even in the case of using a liquid crystal having a voltage-transmittance characteristic which varies corresponding to a temperature change.

According to the present invention, there is provided a liquid crystal apparatus, comprising:

a liquid crystal device comprising a pair of substrates and a liquid crystal disposed between the substrates,

a digital signal processing unit for converting a received digital video signal so as to conform to an electrooptical characteristic of the liquid crystal,

a D/A converter for converting the converted digital signal into an analog signal for controlling the optical state of the liquid crystal, and

data supply means for supplying data for controlling both an input/output characteristic of the D/A converter and a signal conversion characteristic of the digital signal processing unit to the D/A converter and the digital signal processing unit, respectively, so as to apply a voltage conforming to the electrooptical characteristic of the liquid crystal.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a block diagram of an embodiment of the liquid crystal apparatus according to the invention.

FIG. 2 is a block diagram of a signal processing unit for digital gamma-correction used in the embodiment.

FIG. 3 is an equivalent circuit diagram of an embodiment of the memory cell shown in FIG. 2.

FIG. 4 is a circuit diagram of an embodiment of temperature-detection circuit used in the embodiment.

FIG. 5 illustrates an organization of a D/A converter used in the embodiment.

FIG. 6 is a graph showing voltage-transmittance characteristics of a liquid crystal used in the embodiment.

FIG. 7 is a graph showing conversion characteristics of the D/A converter used in the embodiment.

FIG. 8A is a graph showing a correspondence between input gradation levels (video input data) and output gradation levels after gamma-correction based on a liquid crystal characteristic at a higher temperature, and FIG. 8B is an enlarged view of a part A in FIG. 8A.

FIG. 9A is a graph showing a correspondence between input gradation levels (video input data) and output gradation levels after gamma-correction based on a liquid crystal characteristic at a lower temperature, and FIG. 9B is an enlarged view of a part A in FIG. 9A.

FIG. 10A is a graph showing a correspondence between input gradation levels (video input data) and output gradation levels after gamma-correction based on a liquid crystal characteristic at a higher temperature, in the case of digital gamma-correction alone for the purpose of comparison with the embodiment, and FIG. 10B is an enlarged view of a part A in FIG. 10A.

FIG. 11A is a graph showing a correspondence between input gradation levels (video input data) and output gradation levels after gamma-correction based on a liquid crystal characteristic at a lower temperature, in the case of digital gamma-correction alone for the purpose of comparison with the embodiment, and FIG. 11B is an enlarged view of a part A in FIG. 11A.

FIG. 12 is a graph showing a conversion characteristic of a D/A converter for comparison with the D/A converter used in the embodiment.

### DESCRIPTION OF THE PREFERRED EMBODIMENTS

FIG. 1 is a block diagram of an embodiment of the liquid crystal apparatus according to the present invention. Referring to FIG. 1, an 8-bit video data (digital video data or picture data) is converted into an 8-bit video data via a digital gamma-correction unit 103. The resultant 8-bit video data is inputted to a D/A conveter 106 and converted thereby into an analog signal which is supplied to respective pixels of a display unit (liquid crystal panel) 107.

The display unit 107 is provided with a temperature monitor means (temperature detector) 108, by which the temperature of the panel 107 is read outside the panel. The read temperature data is inputted to the digital γ-correction unit 103 and the D/A converter unit 106.

The temperature data is also inputted to a backlight control unit 111, whereby the luminance of a backlight 112 is controlled so as to provide a constant maximum luminance at various temperatures.

The D/A converter 106 is caused to convert its conversion characteristic (input/output characteristic) conforming to the electrooptical characteristic (V-T characteristic) of the liquid crystal at the display unit 107.

In the D/A converter 106, the conversion characteristic (input/output characteristic) thereof is modulated so as to conform to the characteristic of the liquid crystal constituting the display unit 107.

FIG. 5 illustrates an embodiment thereof. In this embodiment, the D/A converter 106 is composed of 8 bits and divided into two stages including an upper 3-bit D/A unit and a lower 3-bit D/A unit, so that the conversion characteristic is modulated in the upper 3-bit D/A unit based on the inputted temperature data. The upper D/A unit includes a resistance 51 divided into 8 sections with 7 nodes. The conversion characteristic is modulated by generating reference voltages Vref1 and Vref2 from a reference voltage generator 113 and supplying the reference voltages Vref1 and Vref2 to nodes of the resistance 51 selected by a selector 114 depending on the output from the temperature monitor (detector) 108. In this instance, the D/A conversion characteristic of the lower D/A unit is set to be linear.

Incidentally, the D/A converter used in the present invention can have another organization as far as its D/A conversion characteristic can be changed during a drive of the display unit.

For example, in this embodiment, the reference voltages have two levels, but a larger number of reference voltages can be adopted in order to effect a better gradational expression. However, the increase in number of reference voltages is accompanied with complication of circuit organization therefor, so that an appropriate number of voltages should be selected in balance with a desired gradation levels.

In this embodiment, the nodes for inputting the reference voltages are selected depending on the temperature. It is however also possible to fix the number of input nodes (to, e.g., 2) and provide a larger number of reference voltages so as to select the fixed number of reference voltages from the larger number of reference voltages depending on the temperature data.

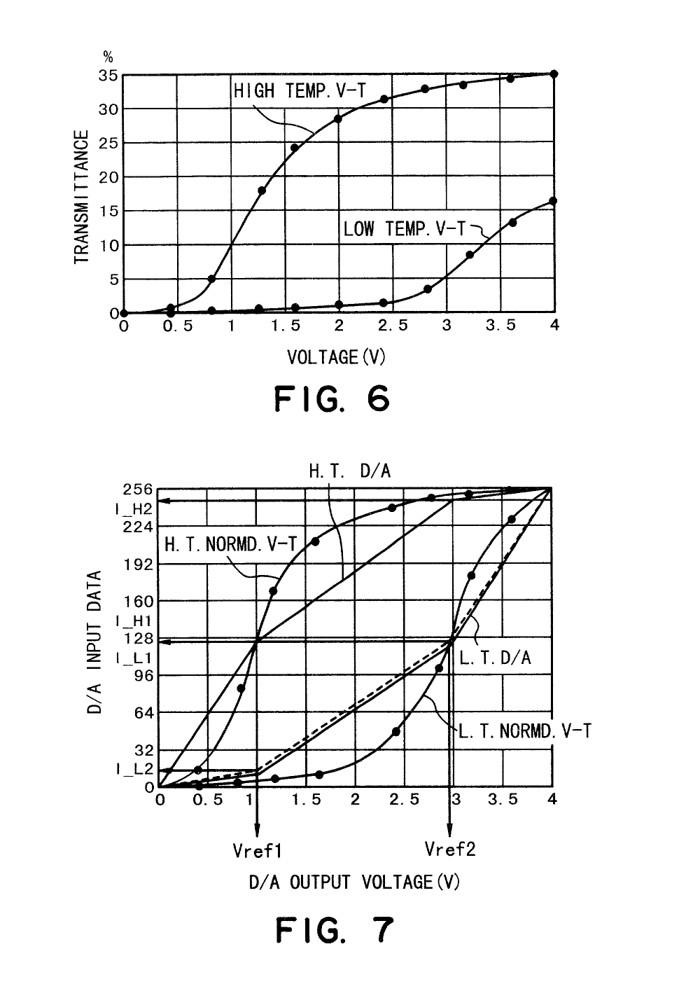

A specific embodiment of the D/A conversion characteristic modulation will be described with reference to FIGS. 6 and 7. FIG. 6 is a graph showing V-T characteristic at higher and lower temperatures of a liquid crystal, and FIG. 7 is a graph sowing corresponding input/output conversion characteristics of a D/A converter. More specifically, the input/output characteristics are set to be represented by flexural lines having flexural points at output voltages of Vref1 and Vref2. So as to conform to the liquid crystal characteristic change, input data (gradation positions) corresponding to Vref1 and Vref2 are changed. More specifically, at a low temperature, input data of I-L1 and I-L2 are inputted so as to output Vref1 and Vref2, respectively, thereby realizing a conversion characteristic at the low temperature. At a high temperature, input data of I-H1 and I-H2 are inputted so as to output Vref1 and Vref2, respectively, thereby realizing a conversion characteristic at the high temperature. For the liquid crystal transmittances correction, normalized liquid crystal transmittance are used for designing the conversion characteristic of the D/A converter 106 as the luminance of the backlight is adjusted so as to provide a substantially constant maximum luminance through the liquid crystal device regardless of the temperature change. The normalized V-T characteristics of a liquid crystal are represented by a curve H.T. NORMD. V-T for a high temperature and a curve L.T. NORMD. V-T for a low temperature in FIG. 7. More specifically, the backlight 112 is controlled to emit a larger output of light at a lower temperature by a backlight controller 111 based on temperature data from the temperature monitor 108. For this purpose, an LED is used as the backlight 112 and subjected to pulse-width modulation. The control of the effective maximum luminance control via the liquid crystal device can also be effected by controlling the output.

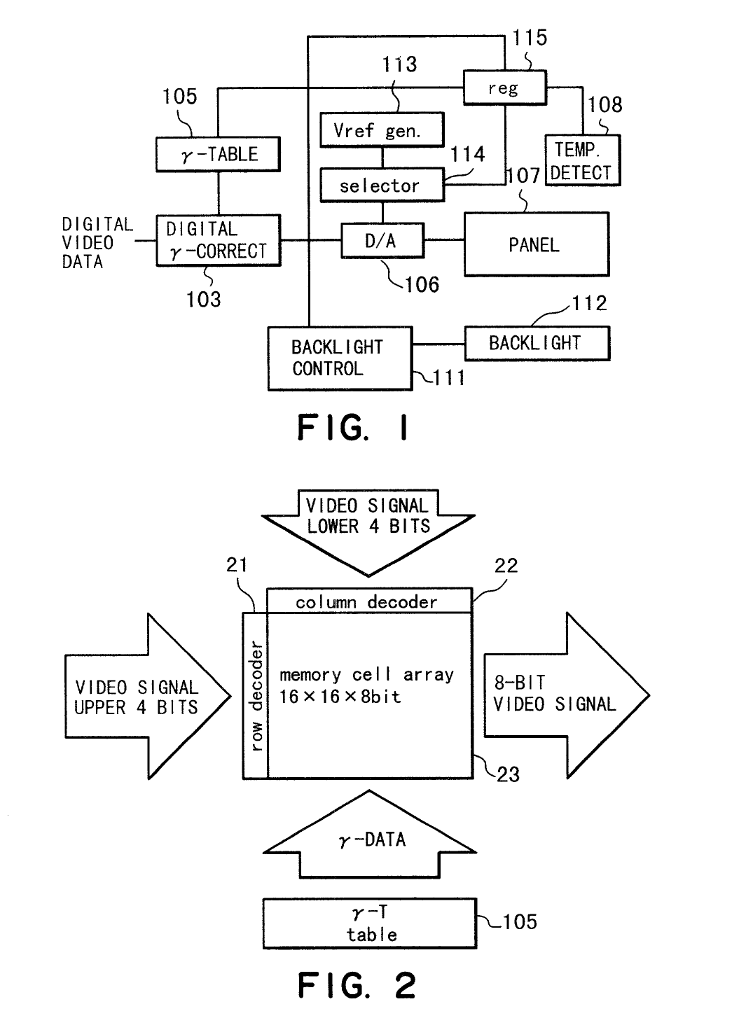

As shown in FIG. 2, a digital gamma-correction unit 103 includes a memory for gamma-correction 23 and rewrites the content of the gamma-correction memory 23 while referring to a gamma-table 105 prepared in advance so as to effect a gamma-correction adapted to a current temperature. Based on the gamma correction memory data, the gamma-correction unit 103 supplies input data to the D/A converter 106 so as to allow output analog data for applying voltages conforming to the electrooptical characteristic of the liquid crystal at the display unit 107 at the temperature.

More specifically, FIG. 2 illustrates an organization and a function of the digital gamma-correction unit 103. Referring to FIG. 2, the gamma-correction unit 103 includes a row decoder 21, a column decoder 22 and a memory cell array of 10×16×8 bits. According to the gamma-correction unit 103, among 8 bits of inputted video signal, upper 4 bits are inputted to a row address of the memory 23 by the decoder 21 and lower 4 bits are inputted to a column address of the memory 23 so as to output a video signal of corresponding 8 bits.

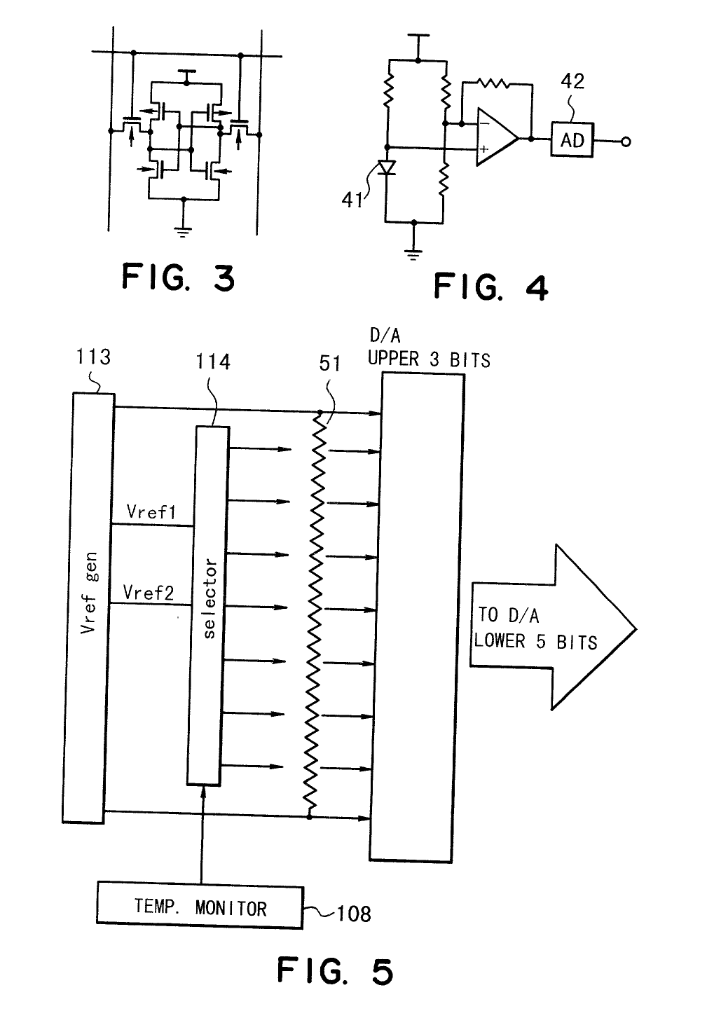

For application to this embodiment, each memory cell constituting the array 23 is desirably a type of cell allowing non-destructive readout, such as an ordinary SRAM cell as represented by a circuit diagram as shown in FIG. 3.

The rewriting of the contact of the memory 23 and the characteristic change in the D/A converter 106 may be effected at any time selected by the designer, e.g., at the time of power-on, each field, every several seconds, every several minutes, etc. It is preferred to use a vertical blanking period for the renewal of the data.

FIG. 4 is a circuit diagram showing an example of temperature monitor means applicable as the temperature detector 108 in this embodiment. The temperature detector includes a pn-diode 41 and an A/D converter 42. In operation, a constant current flows through the pn-diode 41 whereby a forward voltage across the pin-diode 41 becomes proportional to the temperature T. The voltage is read out by the circuit and converted into digital data by the A/D converter 42. As a result, the temperature T is outputted as a digital signal and read out via a register 115 to be supplied to the digital gamma-correction unit 103 and the D/A converter unit 106 shown in FIG. 1.

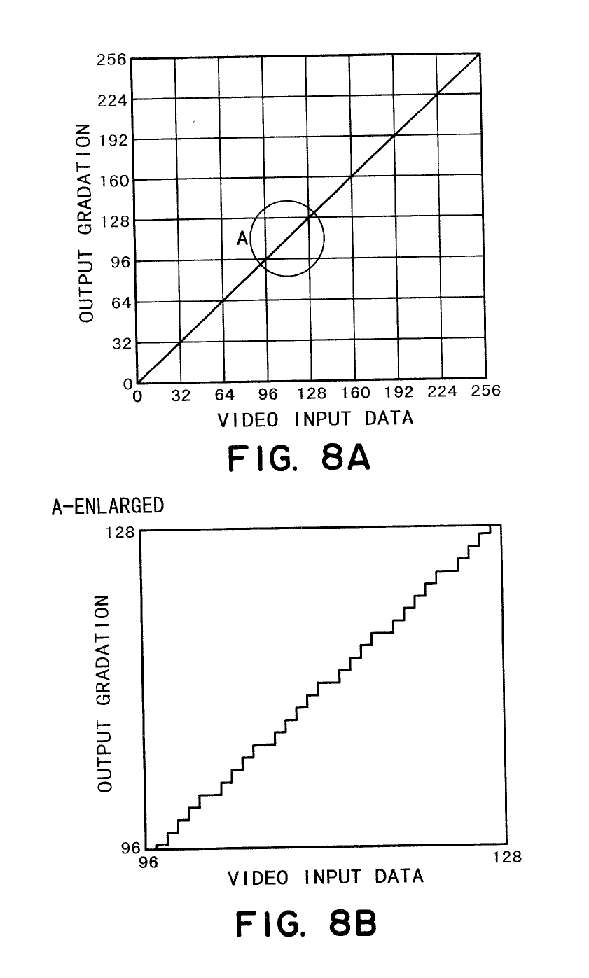

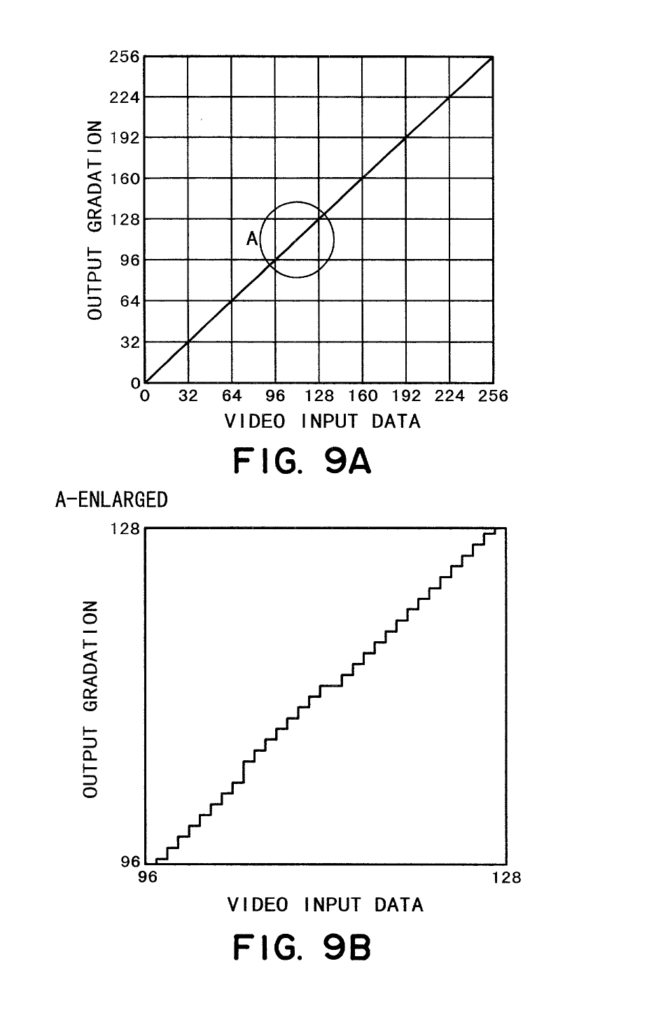

FIGS. 8A and 9A are graphs showing correlations between display luminances and input data corresponding to liquid crystal characteristics at a high temperature and a low temperature, respectively, obtained after the gamma-correction according to this embodiment, and FIGS. 8B and 9B are enlarged views of parts A in FIGS. 8A and 9A, respectively.

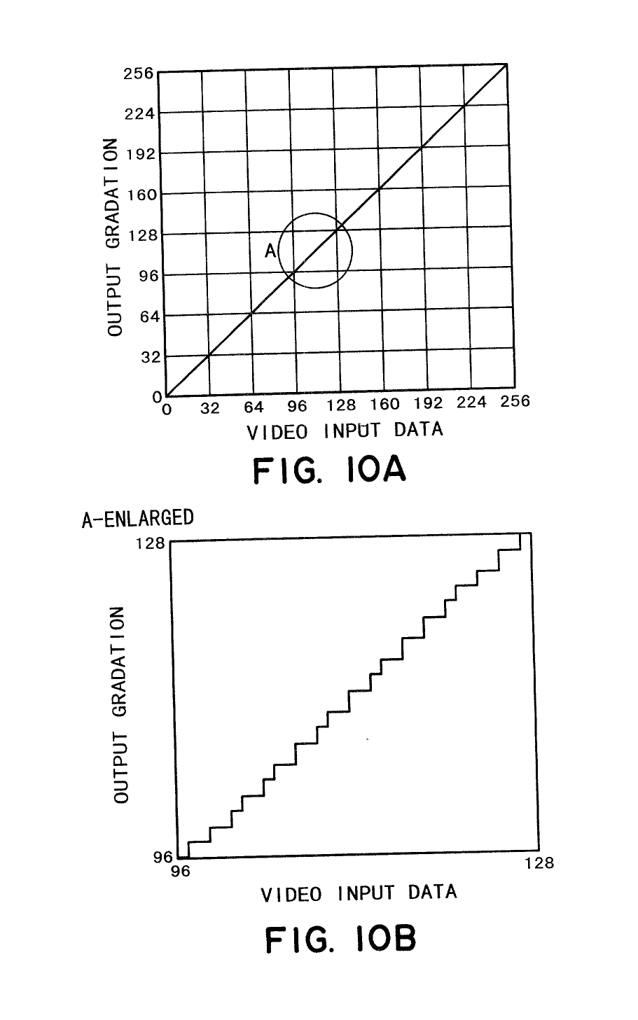

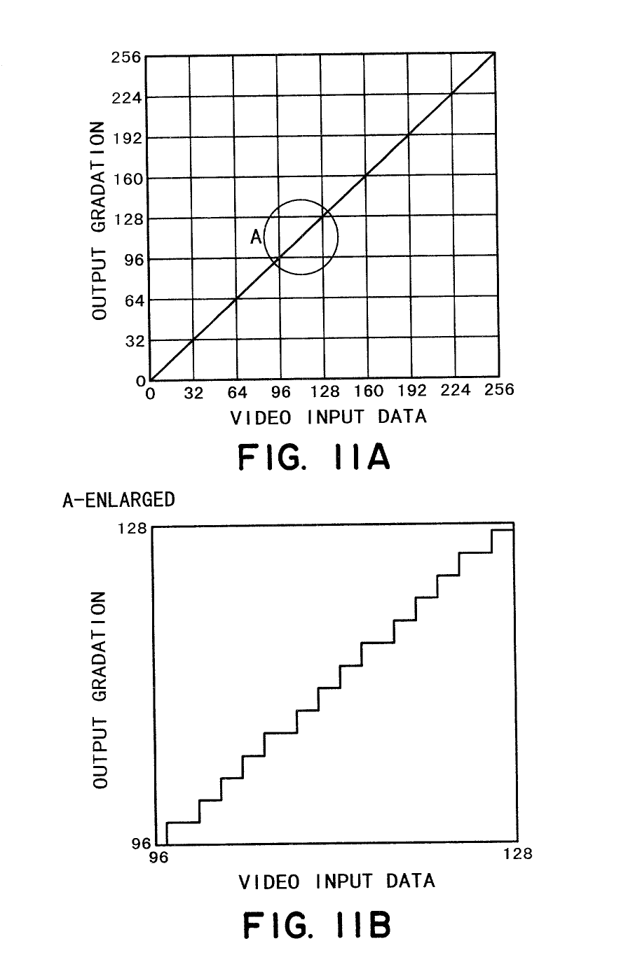

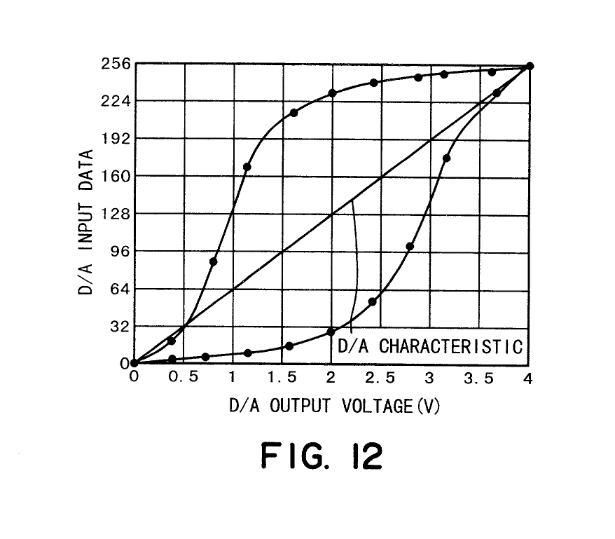

On the other hand, FIGS. 10A and 11A show correlations between display luminances and input data corresponding to liquid crystal characteristics at a high temperature and a low temperature, respectively, obtained after only 8-bit digital gamma-correction for temperature compensation, and FIGS. 10B and 11B are enlarged views of parts A in FIGS. 10A and 11A, respectively.

As is understood from comparison of FIGS. 8B and 9B with FIGS. 10B and 11B, respectively, the embodiment of the present invention allowed more precise gradational reproduction. This is also clear from Table 1 below showing a comparison of number of reproducible gradations according to this embodiment (as represented by FIGS. 8B and 9B) and a comparative operation (as represented by FIGS. 10B and 11B).

TABLE 1
Number of reproducible gradation levels

| | Low temp. | High temp. |
|---|---|---|
| This embodiment | 223 | 219 |
| Comparative | 165 | 172 |

As described above, by modulating digital gamma-correction, D/A conversion characteristic and backlight luminance, all based on measured temperature data, it becomes possible to effect a higher gradation level display.

On the other hand, if only D/A conversion characteristic is modulated corresponding to a temperature change without digital gamma-correction change, good linearity of display luminance in response to given video signals cannot be obtained, thus failing to provide a good display characteristic.

In a more specifically preferred embodiment of the present invention, there is provided a liquid crystal apparatus comprising:

a liquid crystal display including an active matrix substrate having thereon a matrix of plural scanning lines and optical data lines intersecting the scanning lines and a plurality of pixels electrodes each connected via a switching element to an associated intersection of the scanning lines and the data lines, a counter electrode plate disposed opposite to the active matrix substrate, and a liquid crystal disposed between the active matrix substrate and the counter electrode plate,

temperature monitor means disposed on the active matrix substrate,

a digital signal processing unit for converting a received digital video signal so as to conform to the electrooptical characteristic of the liquid crystal,

a D/A converter for converting the converted digital data signal into analog signal, and

control means for modulating the manner of signal processing by the digital signal processing unit and the input/output characteristic of the D/A converter based on an output from the temperature monitor means.

As mentioned above, the present invention is particularly effective in the case of using a liquid crystal having a voltage-transmittance characteristic which varies depending a temperature change. A typical example of such a liquid crystal is a chiral smectic liquid crystal, of which the helical pitch in the bulk stage is longer than twice the cell gap.

In a further preferred embodiment, the liquid crystal device uses a liquid crystal having an alignment characteristic such that the liquid crystal is aligned to provide an average molecular axis to be placed in an monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage is a second polarity opposite to the first polarity at a tilting angle, said tilting angles providing maximum tilting angles β1 and β2 formed under application of the voltage of the first and second polarities, respectively, satisfying β1>β2, preferably β1≧5×β2, as disclosed in EP-A 1079265.

As described above, according to the present invention, there is provided a liquid crystal (display) apparatus capable of exhibiting a good gradation reproduction characteristic even by using a liquid crystal showing a voltage-transmittance characteristic which remarkably varies corresponding to a changing temperature etc.

What is claimed is:

1. A liquid crystal apparatus, comprising:
a liquid crystal device comprising a pair of substrates and a liquid crystal disposed between the substrates,
a digital signal processing unit for converting a received digital video signal,
a D/A converter for converting the converted digital signal into an analog signal for controlling the optical state of the liquid crystal, and
data supply means for supplying data for controlling both an input/output characteristic of the D/A converter and a signal conversion characteristic of the digital signal processing unit to the D/A converter and the digital signal processing unit, respectively.

2. A liquid crystal apparatus according to claim 1, wherein said digital signal processing unit has a number of input bits and a number of output bits which are both equal to a number of bits of the D/A converter.

3. A liquid crystal apparatus according to claim 1, wherein the liquid crystal device comprises an active matrix substrate having thereon a matrix of plural scanning lines and plural data lines intersecting the scanning lines and a plurality of pixel electrodes each connected via a switching element to an associated intersection of the scanning lines and the data lines, a counter electrode substrate disposed opposite to the active matrix substrate, and the liquid crystal disposed between the active matrix substrate and the counter electrode plate.

4. A liquid crystal apparatus according to claim 3, wherein the active matrix substrate further has thereon temperature monitor means providing an output based on which the conversion characteristic of the digital signal processing unit and the D/A conversion characteristic of the D/A converter are changed.

5. A liquid crystal apparatus according to claim 4, wherein the digital signal processing unit includes a conversion table corresponding to the electrooptical characteristic of the liquid crystal, and the content of the conversion table is rewritten based on the output of the temperature monitor means.

6. A liquid crystal apparatus according to claim 4, wherein said display D/A converter is provided with a reference voltage generator which supplies a plurality (n) of reference voltages in addition to 2 source voltages, and the D/A converter is further provided with a plurality (m>n) of nodes for receiving reference voltages so as to allow selection of nodes for receiving the reference voltages to be inputted thereto for changing the input/output characteristic thereof based on the output of the temperature monitor means.

7. A liquid crystal apparatus according to claim 4, wherein said D/A converter is provided with a reference voltage generator which supplies a plurality (n) of reference voltages in addition to 2 source voltages, and the D/A converter is further provided with a plurality (m<n) of nodes for receiving reference voltages so as to allow selection of reference voltages among the plurality (n) of reference voltages to be supplied to the D/A converter via the plurality (m) of nodes for changing the input/output characteristic of the D/A converter based on the output of the temperature monitor means.

8. A liquid crystal apparatus according to claim 1, further including a light source of which the output level is controlled so as to provide an effective maximum luminance emitted via the liquid crystal device.

9. A liquid crystal apparatus according to claim 3, wherein said liquid crystal has a voltage-transmittance characteristic which varies corresponding to a temperature change.

10. A liquid crystal apparatus according to claim 9, wherein said liquid crystal is a chiral smectic liquid crystal.

11. A liquid crystal apparatus according to claim 10, wherein said chiral smectic liquid crystal has a phase transition series of isotropic phase (Iso)-cholesteric phase (Ch)-chiral smectic phase (SmC*), or isotropic phase (Iso)-chiral smectic C phase (SmC*), respectively on temperature decrease.

12. A liquid crystal apparatus according to claim 10, wherein the chiral smectic liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage in a second polarity opposite to the first polarity at a tilting angle, said tilting angles providing maximum tilting angles β1 and β2 formed under application of the voltage of the first and second polarities, respectively, satisfying β1>β2.

13. A liquid crystal apparatus according to claim 12, wherein the maximum tilting angles β1 and β2 satisfies β1≧5×β2.

14. A liquid crystal apparatus according to claim 13, wherein said tilt angle β2 is substantially 0.

15. A liquid crystal apparatus according to claim 10, wherein said chiral smectic has a helical pitch in its bulk state which is longer than twice a gap between the substrates of the liquid crystal device.
